(19) United States
(12) Patent Application Publication
(10) Pub. No.: US 2010/0180245 A1
(43) Pub. Date: Jul. 15, 2010

(54) METHODS AND PRODUCTS FOR DETERMINING AND VISUALIZIN IC BEHAVIOR

(75) Inventor: Martijn J. Rutten, Einhdoven (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP, B.V., Eindhoven (NL)

(21) Appl. No.: 12/377,222

(22) PCT Filed: Aug. 8, 2007
(86) PCT No.: PCT/IB07/53139

§ 371 Date: Feb. 11, 2009

(30) Foreign Application Priority Data
Aug. 11, 2006 (EP) 06118834.8

(51) Int. Cl. G06F 17/50; G06F 11/32; G06F 11/34

(52) U.S. Cl. 716/6; 703/14

(57) ABSTRACT

A method (100) is disclosed for determining the behaviour of an integrated circuit comprising a plurality of resources and being configured to execute a plurality of operations that each require temporary allocation and deallocation of at least a subset of the plurality of resources during said execution. The method comprises the steps of monitoring (130) the execution of at least some of the plurality of operations during an execution run of the IC, capturing (140) events indicating the (de)allocation of resources during said execution, capturing events (150) indicating an operational relationship between allocated resources during said execution, assigning (140, 150) a time stamp to each event; and making (160) the captured events available for visualization. This facilitates the visualization of events that are interrelated in terms of the operation to which they are assigned at a given time instant. This visualization may be realized in the form of a connectivity graph, for which another method (200) is disclosed.

The present invention relates to a method for determining the behaviour of an integrated circuit comprising a plurality of resources and being configured to execute a plurality of operations that each require temporary allocation and deallocation of at least a subset of the plurality of resources to said operations during said execution.

The present invention further relates to a method for visualizing the behaviour of such an integrated circuit.

The present invention yet further relates to respective computer program products that implement the above methods.

The complexity of integrating individual hardware and software components in complex integrated circuits (ICs) such as multi-processor ICs, e.g. systems-on-chip (SoCs) is such that the designer of such ICs requires dedicated tools to ensure that for instance the real-time performance requirements of the IC are met, or to ensure that the various components interact in the correct way. To this end, the IC may be extended with dedicated diagnostic tools, which may be implemented in software or in hardware or a combination thereof. Alternatively, the IC behaviour may be emulated on a programmable hardware platform such as a field-programmable gate array (FPGA) or may be simulated on a computer using a software-based description of the IC functionality, with the diagnostic tools extracting run-time behavioural information from the emulation or simulation. The output of the diagnostic tools is typically provided to a visualizing tool to facilitate the evaluation of the IC behaviour by the designer.

There are several state of the art visualisation tools available to visualize the output of the aforementioned diagnostic tools. A well-known visualization, such as used in the Linux Trace toolkit (retrievable from http://ltt.polymtl.ca), is the display of waveforms associated with the various active resources of the IC as a function of time in a so-called trace view. A problem of such trace views is that the vast amount of displayed information originating from several processes running concurrently on the IC makes it difficult for the designer to detect performance issues or functional faults.

Several solutions have been disclosed that facilitate the debugging of the functional behaviour of an IC. In U.S. Pat. No. 6,101,524, a program storage device is disclosed for establishing the deterministic behaviour of the execution of a thread by a multi-threaded processor. This is non-trivial, because thread execution is typically non-deterministic, for instance because of the sharing of variables by multiple active threads. This complicates the debugging of the functionality of such processors. To this end, all critical events within a predefined interval are recorded, which, by matter of definition, all belong to the same thread, with non-critical events in between said critical events also belonging to this thread. The execution trace of the thread can be replayed using the recorded critical events, thus providing a deterministic representation of the thread execution for facilitating debug operations.

PCT patent application WO 99/05597 A1 disdoses a method to visualize the collaboration between active agents in a multiple-agent software system. Data generated within a software module as well as data communicated between software modules is stored for visualization to facilitate the debugging of the software system behaviour using visual aids.

However, these elaborate solutions are of limited use for visualizing the dynamic resource utilization of a hardware platform such as a SoC, because evaluation of the behaviour of such a system on the software level does not necessarily provide information about potential hardware conflicts or overloading caused by too many multiple operations, such as user-defined operations (use-cases) being executed at the same time.

The present invention seeks to provide a method for determining the behaviour of an integrated circuit comprising a plurality of resources and being configured to execute a plurality of operations that each require temporary allocation and deallocation of at least a subset of the plurality of resources during said execution that facilitates the visual inspection of this behaviour.

The present invention further seeks to provide a method for visualizing the behaviour of such an integrated circuit.

The present invention further seeks to provide respective computer program products that implement said methods.

The present invention further seeks to provide an IC including such a computer program product.

According to a first aspect of the present invention, there is provided a method according to the opening paragraph, comprising the steps of monitoring the execution of at least some of the plurality of operations during an execution run of the integrated circuit; capturing events indicating the allocation of resources during said execution run; capturing events indicating the deallocation of resources during said execution run; capturing events indicating an operational relationship between allocated resources during said execution; assigning a time stamp to each event; and making the captured events available for visualization.

The present invention is based on the realization that during the execution of an operation, or process, on an IC, the IC resources associated with that process will continuously be allocated to and deallocated from such an operation. Moreover, allocated resources may establish communication links with other allocated resources, which is evidence of the resources being involved with the execution of the same operation, i.e. they are operationally related. Hence, by capturing and time-stamping events that indicate the allocation or deallocation of a resource as well as events that capture an operational relationship between allocated resources, it is possible to retrospectively determine which resources were allocated and which allocated resources of the IC were operationally interrelated at a specific time instant.

For instance, for a SoC implementing the various functions of a mobile communication device such as a 3G mobile phone, the operations, or use-cases, may include making a phone call, browsing the internet, accessing e-mail, making or processing a photograph and so on. Such use cases typically trigger SoC processing of data streams, which implies prolonged resource utilization of the SoC during which data is processed and exchanged between allocated resources. The method of the present invention allows detection of which resources of the SoC are allocated to such use-cases at a given point in time.

Preferably, the method further comprises the step of capturing activity information about the allocated resources; and making the captured activity information available. This information facilitates the generation of statistical information such as processor or data communication bus utilization, data communication frequency etcetera for the allocated resources, as well as the visualization of resource activity over time, such as the acquiring and release of a semaphore or the number of cache misses within a predefined period of time.

According to a further aspect of the present invention, there is provided a method for visualizing the behaviour of an integrated circuit comprising a plurality of resources and being configured to execute a plurality of operations that each require temporary allocation and deallocation of at least a subset of the plurality of resources during said execution, said visualizing being facilitated by the events captured by the method according to the first aspect of the present invention, the method comprising receiving the captured events, said events representing a trace of the execution run of the integrated circuit; defining a first time instant inside said trace; generating a set of resources that are allocated at the first time instant from the captured events; constructing a connectivity graph of the allocated resources including existing operational relationships between allocated resources, if any, at the first time instant from the set of allocated resources; and displaying the connectivity graph.

The construction of the connectivity graphs for allocated resources provides a useful filter for the vast amount of data available in conventional trace views, because such graphs make it immediately apparent which resources of the IC are involved with the execution of an operation or process, and gives an overview of what processes, e.g. user-requested operations, run at a given time instant. Moreover, if some or all of the allocated resources have an operational relationship with another allocated resource, i.e. are assigned to the execution of the same operation, this becomes immediately apparent as well. This information is essential in understanding the real-time requirements of such ICs and helps identifying bottlenecks and inefficiencies in the resource allocation in the IC's handling of processes such as use cases.

At this point, it is emphasized that trace views typically do not provide unambiguous allocation information for the resources of an IC. A trace view typically displays activity information of a resource, i.e. gives an insight in when and for how long a resource is active. This, however, is not the same as the resource being allocated. For instance, a resource may remain allocated to an operation in a suspended mode. This cannot be detected from a trace view, because the trace view would merely show an inactive resource, whereas the method of the present invention can routinely distinguish between deactivation and deallocation.

Advantageously, the method comprises the steps of defining a second time instant inside said trace such that the first time instant and the second time instant define a time frame; tracking changes to the set of allocated resources during the progression of the time frame; tracking changes to the operational relationships between allocated resources; modifying the connectivity graph to reflect the tracked changes; and displaying the modified connectivity graph to visualize dynamic changes to the connectivity graph as the play-back of the execution run progresses.

In a preferred embodiment, a modified connectivity graph is displayed for each tracked change. This facilitates a playback of the execution run in a video-like mode, with the ‘images’ in the video stream being the various modified connectivity graphs.

Preferably, the method further comprises the step of receiving captured activity information about the allocated resources, because this facilitates the generation and/or display of additional information such as a trace view and statistical analytical data concerning the respective allocated resources.

These and other aspects of the invention will be apparent from and elucidated with reference to the embodiments described hereinafter.

Embodiments of the present invention will now be described by way of examples only and with reference to the accompanying drawings, in which:

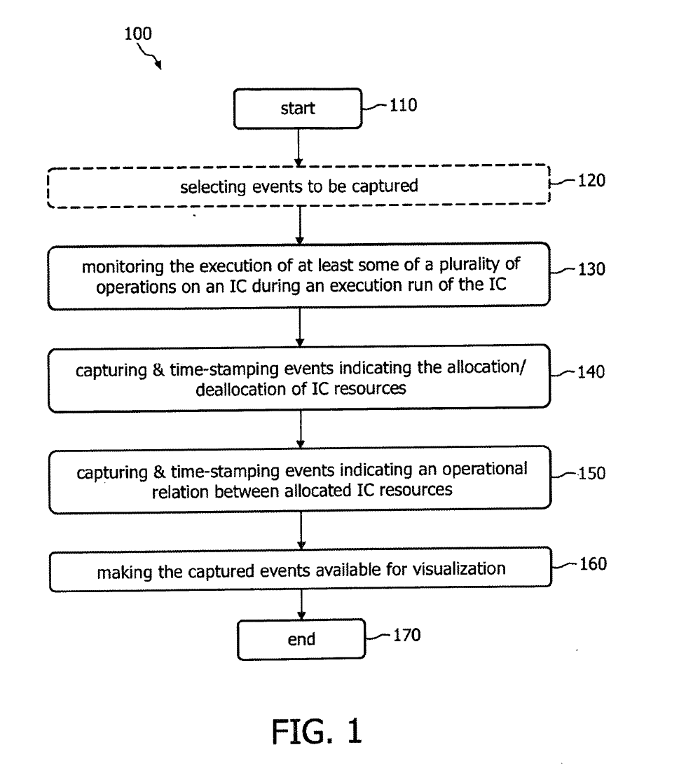

FIG. 1 depicts a flow-chart of an embodiment of a first method of the present invention;

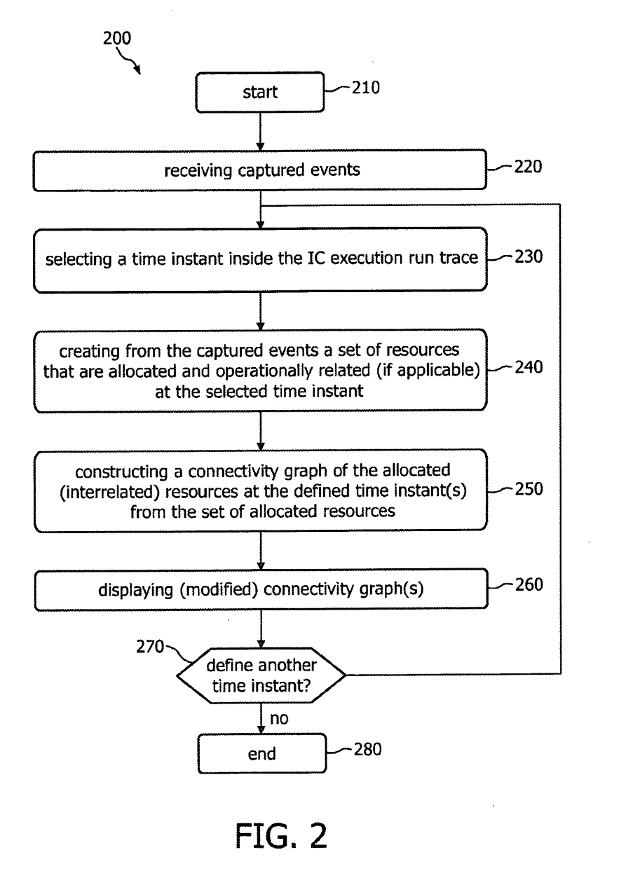

FIG. 2 depicts a flow-chart of an embodiment of a second method of the present invention;

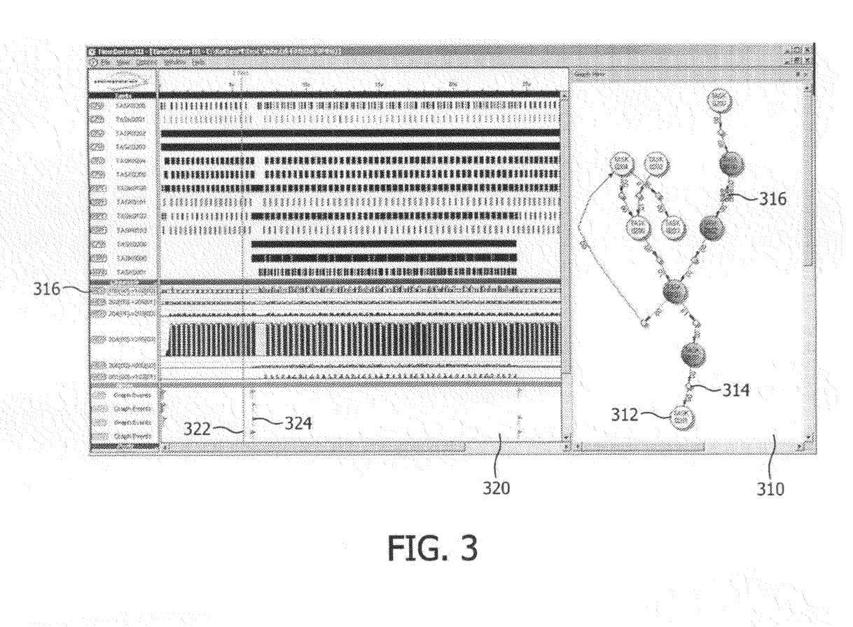

FIG. 3 shows a connectivity graph produced by a computer program product implementing the second method of the present invention; and

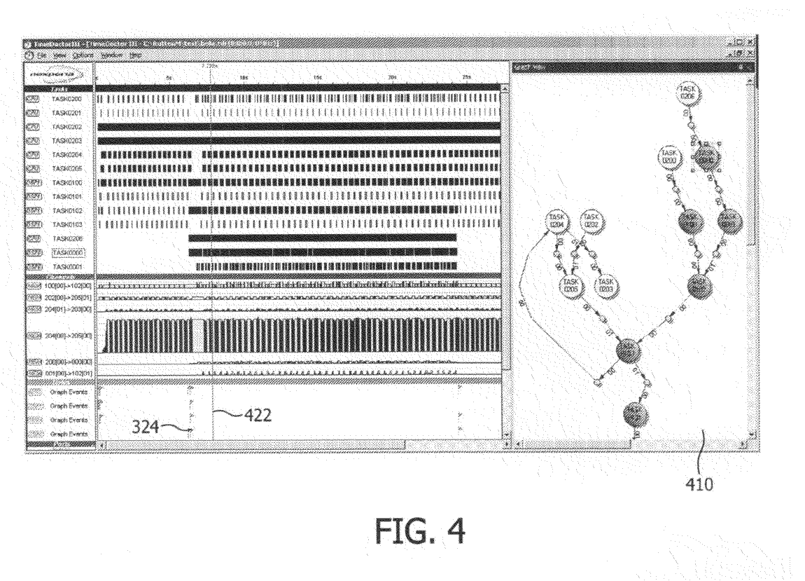

FIG. 4 shows another connectivity graph produced by a computer program product implementing the second method of the present invention.

It should be understood that the Figures are merely schematic and are not drawn to scale. It should also be understood that the same reference numerals are used throughout the Figures to indicate the same or similar parts.

FIG. 1 shows a flowchart of an embodiment of the first method of the present invention, i.e. method 100 of determining the behaviour of an integrated circuit comprising a plurality of resources and being configured to execute a plurality of operations that each require temporary allocation and deallocation of at least a subset of the plurality of resources to said operations during said execution.

After its start 110, which may be user-controlled, the method 100 comprises a step 130 in which it monitors the execution of at least some of the plurality of operations by the integrated circuit or by a model of the integrated circuit during an execution run of the integrated circuit. The execution may run for a time period controlled by a user of the integrated circuit such as a designer, or may run until an event takes place, such as a system crash or a buffer becoming full and so on. The execution run is typically long enough to ensure that sufficient data is acquired to allow for useful analysis of the performance of the integrated circuit. It is emphasized that the method 100 may be applied to an integrated circuit or models thereof, e.g. an emulation of the IC on a configurable device such as a FPGA, or a computer simulation of the IC that typically uses a high-level design description, e.g. a System-C description of the IC functionality, a netlist description of the IC, or a description derived from such a netlist.

In steps 140 and 150, which are performed during said monitoring, events are captured and time-stamped, i.e. labelled with information allowing the determination of the point in time during the execution run at which they occurred, that relate to the allocation, deallocation and operational interrelations between resources of the integrated circuit. The time-stamping may take place substantially simultaneously with the capturing of the events. The captured events may be a subset of all events occurring during said execution. For instance, the subset of events may be predefined or may be selected in an optional step 120 preceding the monitoring step 130.

Examples of events signalling the allocation/deallocation of a resource, e.g. an individual component, of the IC to an operation include the creation/deletion of an operating system task, the allocation/deallocation in memory of a queue, the creation/deletion of a semaphore, and so on. Allocation and deallocation events may be detected from the occurrence of a corresponding instruction in the instruction flow to the one or more processing units of the IC, e.g. an instruction that triggers a CPU to (de)allocate memory resources for a buffer in memory.

Examples of events indicating an operational relationship between allocated resources during said execution comprise the creation or deletion of a communication path between two processing elements, the opening or assignment of a communication port by an individual component, for instance to/from a buffer or another storage element, the assignment of a semaphore to a resource and so on. An operational relationship between allocated resources, i.e. the determination of allocated resources that are involved with the execution of the same operation or task, may be established by detecting the setup of communication paths between two resources, e.g. by corresponding instructions in the aforementioned instruction flow.

In step 160, the captured events are being made available for visualization. Step 160 may be executed during or after the execution of the operations by the integrated circuit or integrated circuit model, and may comprise one or more additional filtering and formatting steps before the captured events are made available. The method is subsequently terminated in step 170.

At this point, it is emphasized that the method may comprise an optional step of capturing activity information about the allocated resources; and making the captured activity information available. Such activity information may include information about activation or suspension of an allocated resource, e.g. the acquisition or release of a semaphore, which gives or takes away the control of a resource over a shared commodity such as a shared variable, a value change in a counter, as well as information about communication activity by a resource, for instance to allow evaluation of the performance and load of a resource during the execution run.

An example of an output produced by the method 100 is given below. The output, e.g. a formatted file, consists of a number of lines, each starting with a tag and followed by tag parameters. The file may be parsed on a tag per line basis, with each tag being followed by parameters associated with the tag. The file typically comprises the following information:

I. Information about the Timing Behaviour of the Ic that has been Monitored.

This timing information may be generated by an additional step (not shown) of method 100.

CPU <id> [<name>]

This tag is used to identify a central processing unit (CPU) for an IC having multiple CPUs. The tag indicates the name of the CPU, and it is assumed that all tags following this tag until the next CPU tag in the file pertain to this CPU. A multi-CPU file may be a concatenation of multiple single CPU files each preceded by a CPU tag.

SPEED <clocks per sec>

Indicates the number of true clock cycles per second in the target system's time base, e.g. the clock frequency at which the IC executes the operations.

MEMSPEED <clocks per sec>

Indicates the number of true clock memory cycles per second on the target system's memory bus, e.g. the clock frequency of the data communication over a memory bus of the IC.

II. Information about the Allocation and Deallocation of Resources of the Integrated Circuit During the Monitored Execution and Information Determining an Operational Relationship Between Allocated Resources:

CRE<type> <id> <time> [<prod_id> <cons_id>] [<prod_cpu_id> <cons_cpu_id>]

Represents a creation of a task, ISR, queue, or connection associated with a resource such as a CPU, i.e. an event indicating the allocation of resources during the execution trace of the IC. The type parameter indicates the type of event that the event pertains to. Possible values for type are for instance:

0 Task Created

1 Interrupt Service Routine Created
3 Queue Created
10 Channel Created
11 Port Created

The ID parameter indicates the specific task/ISR/queue/connection. ID numbers must be unique across different types, e.g. there cannot be a task and a semaphore with the same ID. The time parameter indicates the time stamp of occurrence for this event, which may be expressed in ticks having a predefined frequency. The optional prod_id and cons_id parameters represent the producer and consumer tasks/ISRs/channels on a connection. the prod_cpu_id and cons_cpu_id may be the IDs of the respective resources, e.g. CPUs on which the producer and consumer are created.

DEL <type> <id> <time>

Represents a destruction (deallocation) of a task, ISR, queue, or connection associated with a resource such as a CPU, i.e. an event indicating the deallocation of a resource during the execution trace of the IC. The type parameter indicates the type of event that the event pertains to. Possible values for type are for instance:

0 Task Deleted

1 Interrupt Service Routine Deleted
3 Queue Deleted
10 Channel Deleted
11 Port Deleted

The ID parameter indicates the specific task/ISR/queue/connection. The time parameter is the time stamp indicating the time of occurrence for this event, which may be measured in ticks, as previously explained.

III. Activity Information about Allocated Resources:

STA<type> <id> <time> [<size>]

Represents a start sample of a task, ISR, etcetera associated with a resource such as a CPU. The type parameter indicates the type of event that the event pertains to. Possible values of for type are for instance:

0 Task Start

1 Interrupt Service Routine (ISR) Start
2 Semaphore Acquire
3 Queue Send/Write
4 Event Send
8 Agent Start
10 Channel Send/Write
11 Port Send/Write

The ID parameter indicates the specific task/ISR/semaphore etcetera for this sample. The time parameter is the time stamp indicating the time of occurrence for this sample, which may be measured in ticks. The optional size parameter may be used for queues, channels, and ports. The parameter represents the number of data elements/packets sent.

STO<type> <id> <time> [<size>]

Represents a stop sample for a task, ISR, etcetera. The type parameter indicates the type of event that the event pertains to. Possible values of type are for instance:

0 Task Stop

1 Interrupt Service Routine Stop

2 Semaphore Release

3 Queue Receive/Read

4 Event Receive

8 Agent Stop

Channel Receive/Read

11 Port Receive/Read

The ID parameter indicates the specific task/ISR/semaphore etcetera for this sample. The time parameter is the time stamp indicating the time of occurrence for this sample, which may be measured in ticks as previously explained. The optional size parameter is only used for queues (type 3), and represents the number of data elements/packets sent.

The information types of categories I and II can be used to determine the infrastructure in terms of allocated resources involved with an operation at a particular time instance of an execution trace of an IC. The following example sets up a buffered connection between two tasks A and B:

CRE 0 <task_a_id> <time>

CRE 0 <task_b_id> <time>

CRE 10 <channel_id> <time>

CRE 11 <a_port_id> <time> <task_a_id> <task_a_cpu_id> <channel_id> <channel_cpu_id>

CRE 11 <b_port_id> <time> <channel_id> <channel_cpu_id> <task_b_id> <task_b_cpu_id>

STA 11 <a_port_id> <time>10

STO 11 <b_port_id> <time>5

In the above example, task A produces 10 samples on the channel via its output port a_port_id, and task B consumes 5 samples from the channel via its input port b_port_id. The information that tasks A and B belong to the same operation can for instance be extracted from the CRE11 statements that set up a communications channel between these tasks.

The output generated by the method 100 may further comprise information that can be used when displaying the output. Examples of such information include:

DSC <type> <id> <value>

Represents a description of a preceding sample (STA/STO/OCC). The type parameter indicates the type of description provided. Possible values of for type are:

| | | |
|---|---|---|
| 0 | String | Indicates string value to be displayed when mouse |
| | | hovers over sample |
| 1 | Number | Indicates numeric value to be displayed when |
| | | mouse hovers over sample |
| 2 | Time | Indicates value in ticks to be displayed when |
| | | mouse hovers over sample. |
| 3 | Colour | Value indicates colour index for use in display. |

The ID parameter indicates the specific variable described.

DNM <id> <name>

Specifies the display name for the given description ID, thus allowing the recognition of a resource when displayed.

NAM <id> <name>

Specifies the display name for the given sample line, thus allowing the recognition of the sample when displayed.

The output produced by the method 100 facilitates a more detailed analysis of the information retrieved from an execution trace of an integrated circuit (model) under investigation.

A more detailed analysis of this data is facilitated by the second method 200 of the present invention, i.e. a method for visualizing the behaviour of an integrated circuit comprising a plurality of resources and being configured to execute a plurality of operations that each require temporary allocation and deallocation of at least a subset of the plurality of resources during said execution, said visualizing being facilitated by the events captured by the various embodiments of method 100. An embodiment of method 200 is given in FIG. 2. The method 200 provides more powerful and intuitive visualization of the execution trace information.

After its initialisation in step 210, the method 200 comprises a step 220 of receiving the events captured in an execution trace of an IC or IC model under investigation, e.g. reading in the output file produced in step 160 of method 100. In step 230, a time instant with respect to the execution run of the IC in step 130 of method 100 is selected. In step 240, this time instant is used to select all events received in step 210 that are allocated. The allocated resources may be operationally related to other allocated resources, e.g. have a communication channel established between each other, but this is not necessary; an operation may only have a single allocated resource at some point during its execution.

For example, a task that has been created before the selected time instant and has not been deleted at the selected time instant is an allocated task, and a channel between this task and another resource that has been created before the selected time instant and has not been deleted at the selected time instant indicates an operational relationship of this task with the other resource, e.g. another task.

The set of allocated resources selected in step 240 is used in step 250 to construct a connectivity graph for the allocated resources in the set. This graph is displayed in step 260. The graph may comprise interconnected allocated resources, which signals an operational relationship between these resources, and may comprise unconnected allocated resources, which signals resources that are assigned to an operation without having an operational relationship with another allocated resource, as previously explained.

Although not explicitly shown in FIG. 2, it is emphasized that the method 200 may comprise optional additional steps. For instance, the method 200 may comprise the additional step of receiving captured activity information for the respective allocated resources, which can be used for a number of purposes. For instance, the captured activity information may be displayed as a trace view in a separate window to the window in which the connectivity graph is shown. The trace view will typically comprise all resources that have been allocated at some stage during the execution run and will show the activity information for these resources, e.g. signal waveforms indicating resource activity. The activity information can also be used to generate statistical information for the resource to which the activity information belongs. Such statistical information may comprise information regarding the load utilization of the resource, the number of data communications received and/or sent by the resource and so on. The statistical information of a resource may be made available by selecting the representation of the resource in the connectivity graph or in the trace view.

An example of a display output of step 260 is shown in FIG. 3. The display output shown in FIG. 3 has been generated by the execution of a computer program product of the present invention implementing the method 200 (vide infra). The output includes a connectivity graph 310 in a first window and a trace view in a second window 320. The trace view is an optional view, which is generated from the received activity information for the respective resources. It will be appreciated that the earliest activity of the resource indicates that the resource has become allocated to an operation, but that the activity information fails to indicate when the resource is actually deallocated from its operation, as previously explained.

The connectivity graph 310 displays operationally related resources 312 of an IC under evaluation at a time instant 322. The operational relationship between the resources 312 is indicated by channels 314, which may comprise buffer elements, as indicated by the balls on the channels 314. The connectivity graph is displayed in the form of a data flow graph by way of example only; other display formats of the connectivity graph are equally feasible. The trace view 320 further comprises markers 324 indicating a graph event, such as the allocation or deallocation of a resource. The markers 324 may be hyperlinks to allow a user to quickly select the time instant and graph associated with the graph event. The markers may be generated by the method 200 upon evaluation of the received events during step 240. Alternatively, the markers may be generated in conjunction with the generation of the connectivity graph in step 250, or in a separate step of the method 200. The trace view 320, which typically displays the activity information of resources that have become active at some stage during the execution run of the IC or IC model. The trace view 320 may be generated prior to the execution of method steps 230, 240 and 250 to allow a user to define the first time instant.

At this point, it is emphasized that the inclusion of the trace view 320 in the display output is preferable but not necessary. Moreover, the definition of the time instances for which the connectivity graphs are to be generated do not have to be selected graphically; a text-based input is equally feasible.

The display output of FIG. 3 may comprise additional functionality created by optional steps in the method 200 to allow further information retrieval. For instance, as indicated by reference numeral 316, the resources in the connectivity graph 310 may be selected to facilitate highlighting the corresponding representation of the resource in the trace view 320 and vice versa. The resources may also be selected to bring up the aforementioned statistical data for the selected resource, e.g. by double-clicking the representation of the resource in the connectivity graph 310 or in the trace view 320. Other information that may be made available this way includes status information about a resource at the current time instant of the execution run playback and information about the properties of a resource.

Also, in the case where the activity information comprises a data communication event between a first allocated resource and a second allocated resource, the step 260 of displaying a connectivity graph may comprise displaying a token representing the data communication event and moving the token from the first allocated resource to the second allocated resource. For instance, the token may be the ball-shaped representation of buffer 314 in connectivity graph 310, which may be displayed as sliding over the displayed connection from task 0101 to task 0201 upon the occurrence of a data communication from task 0101 to task 0201. Alternatively, a separate token may be used that slides from task 0101 to task 0201 via buffer 314 upon the occurrence of a data communication via this buffer. Other graphical representations of this optional functionality will be immediately apparent to the skilled person.

Similarly, a semaphore may be displayed using a token, with the resources involved with the semaphore all being labelled with the token, with the resource having the semaphore in its possession having a highlighted token. Alternatively, the token may only be shown at the resource possessing the token, with a change in possession being indicated by a transfer of the token to its new owner.

Now, returning to FIG. 2, prior to its termination step 280, the method 200 may comprise the optional step 270 of checking whether a further time instant is to be defined to facilitate the visualization of changes to the connectivity graph generated for the first time instant. This triggers the repeat of the steps 230, 240 and 250 for defining the further time instant and construction the further connectivity graph for the further time instant, or to construct a stream of connectivity graphs highlighting each change to the connectivity graph in the time frame that runs from the first time instant to the further time instant. The latter implementation provides a video-style playback mode of the execution run.

FIG. 4 shows another example of a display output by the computer program product implementing the method 200. The selected further time instant 422 has progressed in time in comparison to the time instant 322 selected in FIG. 3. It is immediately apparent that the time frame defined by the time instant 322 and the further time instant 422 includes a number of graph events 324; these graph events are reflected by the modifications to the connectivity graph 410 when compared to the connectivity graph 310.

In FIG. 4, the connectivity graph 310 has been replaced by connectivity graph 410. However, it is equally feasible to show both graphs, e.g. in separate windows to facilitate comparison between them. The changes to the connectivity graph 310 as signalled by the aforementioned graph events may be displayed in a streaming fashion, i.e. by showing a sequence of modified graphs for subsequent changes to the set of allocated resources, to give the user of the visualization tool an impression of the dynamic changes to resource utilization during the execution of an operation by a monitored IC or IC model. It will be understood that in case of more than one active operation at a defined time instant, the display output may comprise different connectivity graphs corresponding to the different operations, and that these graphs may be displayed in separate windows.

It will be appreciated that the order of the method steps of method 200 as shown in FIG. 2 may be altered without departing from the scope of the present invention. For instance, the method 200 may start with the generation of the connectivity graphs changes thereto for the whole predefined period, and the graph information may be stored in the memory of a device executing the method 200, e.g. a computer running a computer program product implementing method 200, after which the execution of step 230, i.e. the user-selected time instant for visualization of the operation-related execution trace information cause the retrieval of the appropriate graph information from the memory. Other variations will be immediately apparent to the skilled person.

The various embodiments of methods 100 and 200 may be implemented as computer program products, e.g. application software programs, which may be stored on a suitable data carrier such as a memory or an optical disk such as a DVD or CD, or may be retrievable from a remote location using the internet, with the method steps being implemented by means of suitable sets of instructions for execution by a processor of a computer. In the context of the present invention, a set of instructions comprises one or more instructions. The implementation of the methods 100 and 200 of the present invention in the form of the aforementioned computer program products can be achieved by those skilled in the art using their common general knowledge, and will therefore not be explained in detail here.

In other words, the present invention discloses respective computer programs, which, when executed by a processor cause the processor to carry out the various embodiments of method 100 and method 200.

In addition, the method 100 of the present invention may be implemented on an integrated circuit, either by means of hardwired logic that implement the method steps when in operation, or by means of the aforementioned computer program product stored in the memory of the integrated circuit, in which case a processing unit of the IC is arranged to implement the steps of method 100 by executing the computer program product. The IC typically comprises at least one hardware module having plurality of resources, the module being configured to execute a plurality of operations that each require temporary allocation and deallocation of at least a subset of the plurality of resources during said execution. An example of such an IC is a SoC, which typically comprises a number of modules that each fulfil a specific part of the functionality of the IC. The presence of the computer program product, or the hardwired logic, inside such modules facilitates the determination of the behaviour of the module during the execution of (user-defined) operations, e.g. use cases, which can aid a system designer or a purchaser of the IC to better understand the capabilities and limitations of the IC in operation. To this end, the IC may comprise one or more output pins, which may be dedicated, onto which data indicating the captured events is made available.

In operation, the computer program product, which is typically executed on a processing unit inside or associated with the module, or the hardwired logic, may make the captured events directly available to the outside world, e.g. via the (dedicated) output pin, or may write the captured events to a memory of the IC, after which the processed data is made available to the outside world, typically upon completion of the execution run. The latter is advantageous if the execution run speed of the IC is much higher than the communication speed via the output pins of the IC. The IC may be a configurable logic device such as a FPGA, which emulates the functionality of another IC, e.g. a SoC.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. A method of determining the behaviour of an integrated circuit comprising a plurality of resources and being configured to execute a plurality of operations that each require temporary allocation and deallocation of at least a subset of the plurality of resources during said execution, the method comprising:
monitoring the execution of at least some of the plurality of operations during an execution run of the integrated circuit;
capturing events indicating the allocation of resources during said execution run;
capturing events indicating the deallocation of resources during said execution run;
capturing events indicating an operational relationship between allocated resources during said execution run;
assigning a time stamp to each event; and
making the captured events available for visualization.

2. A method as claimed in claim 1, further comprising the step of:
capturing activity information for the respective resources; and making the captured activity information available.

3. A method as claimed in claim 1, further comprising selecting the events to be captured prior to the monitoring step.

4. A method as claimed in claim 1, further comprising providing the captured events to an output of the integrated circuit, and wherein the step of assigning the time stamp to each event is performed external to the integrated circuit.

5. A method as claimed in claim 1, further comprising providing a software model of the integrated circuit, and wherein the monitoring is performed on a simulated execution by the software model.

6. A method for visualizing the behaviour of an integrated circuit comprising a plurality of resources and being configured to execute a plurality of operations that each require temporary allocation and deallocation of at least a subset of the plurality of resources during said execution, said visualizing being facilitated by the events captured by the method of claim 1, the method comprising:
receiving the captured events, said events representing a trace of the execution run of the integrated circuit;
defining a first time instant inside said trace;
generating a set of resources that are allocated at the first time instant from the captured events;
constructing a connectivity graph of the allocated resources including existing operational relationships between allocated resources, if any, at the first time instant from the set of allocated resources; and
displaying the connectivity graph.

7. A method as claimed in claim 6, further comprising:
defining a second time instant inside said trace such that the first time instant and the second time instant define a time frame;
tracking changes to the set of allocated resources during the progression of the time frame;
tracking changes to the operational relationships between allocated resources;
modifying the connectivity graph to reflect the tracked changes; an
displaying the modified connectivity graph.

8. A method as claimed in claim 7, wherein a modified connectivity graph is displayed for each tracked change.

9. A method as claimed in claim 6, further comprising receiving captured activity information for the respective resources.

10. A method as claimed in claim 9, further comprising:
displaying the connectivity graph in a first window; an
displaying the captured activity information in a further window.

11. A method as claimed in claim 6, the method further comprising:
evaluating the received captured events to identify an event indicating the allocation or deallocation of a resource; and
displaying a marker in the further window at a time instant corresponding to the time stamp of the identified event.

12. A method as claimed in claim 10, wherein the first time instant is selected from the further window.

13. A method as claimed in claim 9, further comprising:
deriving, for each resource, statistical information from the received captured activity information;
selecting a displayed resource from the displayed connectivity graph; and
displaying the statistical information of the selected resource.

14. A method as claimed in claim 9, wherein the captured information comprises a data communication event between a first allocated resource and a second allocated resource, and wherein the step of displaying a connectivity graph comprises:
displaying a token representing the data communication event; and
moving the token from the first allocated resource to the second allocated resource.

15. A computer program product for determining the behaviour of an integrated circuit comprising a plurality of resources and being configured to execute a plurality of operations that each require temporary allocation and deallocation of at least a subset of the plurality of resources during said execution, the computer program product comprising:
a set of instructions for capturing events indicating the allocation of resources during the execution of at least some of the plurality of operations by the integrated circuit during an execution run of the integrated circuit;
a set of instructions for capturing events indicating the deallocation of resources during said execution;
a set of instructions for capturing events indicating an operational relationship between allocated resources during said execution;
a set of instructions for assigning a time stamp to each event; and
a set of instructions for making the captured events available for visualization.

16. A computer program product as claimed in claim 15, further comprising:
a set of instructions for capturing activity information for the respective resources; and
a set of instructions for making the captured activity information available for visualization.

17. A computer program product as claimed in claim 15, further comprising a set of instructions for selecting the events to be captured prior to the execution step.

18. A computer program product as claimed in claim 15, wherein the set of instructions for making the captured events available comprise a set of instructions for storing the captured events in a memory and a set of instructions for forwarding the captured events from the memory to at least one output of the integrated circuit.

19. A computer program product as claimed in claim 15, wherein the event capturing a set of instructions are arranged to capture said events from a simulation of the execution of at least some of the plurality of operations by the integrated circuit during a simulated execution run.

20. An integrated circuit comprising at least one module comprising:
a plurality of resources, the module being configured to execute a plurality of operations that each require temporary allocation and deallocation of at least a subset of the plurality of resources during said execution; and
means for implementing the steps of the method as claimed in claim 1.

21. An integrated circuit as claimed in claim 20, wherein the means comprise a memory comprising a computer program product as claimed in claim 15.

22. A computer program product for visualizing the behaviour of an integrated circuit comprising a plurality of resources and being configured to execute a plurality of operations that each require temporary allocation and deallocation of at least a subset of the plurality of resources during said execution, said visualizing being facilitated by the events captured by the computer program product of claim 15, the computer program product comprising:
a set of instructions for receiving the captured events;
a set of instructions for defining a first time instant inside the execution run;
a set of instructions for generating a set of resources that are allocated at the first time instant from the captured events;
a set of instructions for constructing a connectivity graph of the allocated resources including existing operational relationships between allocated resources, if any, at the first time instant from the set of allocated resources; and
a set of instructions for displaying the connectivity graph.

23. A computer program product as claimed in claim 22, further comprising:
a set of instructions for defining a second time instant inside the execution run such that the first time instant and the second time instant define a time frame;
a set of instructions for tracking changes to the set of allocated resources during the progression of the time frame;
a set of instructions for tracking changes to the operational relationships between allocated resources;
a set of instructions for modifying the connectivity graph to reflect the tracked changes; and
a set of instructions for displaying the modified connectivity graph.

24. A computer program product as claimed in claim 23, wherein the set of instructions for displaying the modified connectivity graph is configured to display a modified connectivity graph for each tracked change.

25. A computer program product as claimed in claim 22, further comprising a set of instructions for receiving captured activity information for the respective resources.

26. A computer program product as claimed in claim 25, further comprising:
a set of instructions for displaying the connectivity graph in a first window; and
a set of instructions for displaying the captured activity information in a further window.

27. A computer program product as claimed in claim 26, the method further comprising:
a set of instructions for evaluating the received captured events to identify an event indicating the allocation or deallocation of a resource; and
a set of instructions for displaying a marker in the further window at a time instant corresponding to the time stamp of the identified event.

28. A computer program product as claimed in claim 26, wherein the first time instant is selected from the further window.

29. A computer program product as claimed in claim 25, further comprising:
a set of instructions for deriving, for each resource, statistical information from the received captured activity information;
a set of instructions for selecting a resource from the displayed connectivity graph; and
a set of instructions for displaying the statistical information of the selected resource.

30. A computer program product as claimed in claim 25, wherein the captured information comprises a data communication event between a first allocated resource and a second allocated resource, and wherein the set of instructions for selecting a displayed allocated resource of displaying a connectivity graph comprises:
a set of instructions for selecting a displayed allocated resource displaying a token representing the data communication event; and
a set of instructions for selecting a displayed allocated resource moving the token from the first allocated resource to the second allocated resource.

31. A data carrier carrying a computer program product as claimed in claim 15.

32. A data carrier carrying a computer program product as claims in claim 22.
